(19) United States
(12) Patent Application Publication
(10) Pub. No.: US 2010/0053223 A1
(43) Pub. Date: Mar. 4, 2010

(54) GRADATION CONTROL METHOD AND DISPLAY DEVICE

(75) Inventors: Shoji OTSUKA, Tokyo (JP); Takashi Okamoto, Tokyo (JP); Kazuya Maeshima, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Chiyoda-du (JP)

(21) Appl. No.: 12/370,988

(22) Filed: Feb. 13, 2009

(30) Foreign Application Priority Data
Aug. 29, 2008 (JP) 2008-222031

(51) Int. Cl. G09G 3/30; G09G 5/10

(52) U.S. Cl. 345/690; 345/76

(57) ABSTRACT

The present invention relates to a gradation control method, for a display device, in which one frame is divided into a plurality of subframes and lighting times for pixels corresponding to the subframes are controlled based on the sum of respective light-emitting times in the subframes, so that gradations of the pixels are rendered; the frame is divided into n (positive integer) subframes (e.g., SF1′ to SF4′) in each of which m (positive integer)-bit data is set and a subframe (SF5′) in which p (positive integer smaller than m)-bit data is set. As a result, increase in a data setting time can be suppressed, even if the number of subframes is increased in order to enable complicated gradation control.

### BACKGROUND OF THE INVENTION

1. Field of the Invention

The present invention relates to a display device in which display elements such as LED light emitting elements or EL (electroluminescence) elements are arranged in a matrix manner, and particular to a gradation control method of controlling gradation by controlling the light emitting times of display elements as pixels through a PWM (pulse width modulation).

2. Description of the Related Art

In a time-division driving method in which the light emitting times of pixels (image elements) are controlled so that the gradation is controlled, a single frame is divided into a great number of subframes so that the gradation is displayed.

In the foregoing time-division driving method, pixels are divided into ones in a light-emitting state and the other ones in a non-light-emitting state in response to a digital data signal during the respective time periods of the subframes so that the respective gradations of the pixels are rendered in a single frame period.

FIG. 12, which is a chart, for example, the same as FIG. 2 of Japanese Patent Laid-Open Pub. No. 2005-316382, represents the data timing, through a time-division drive, of a typical EL display device.

In a conventional time-division driving method represented in FIG. 12, for the purpose of rendering the gradation of a digital data signal, each frame is divided into a great number of subframes (SFs) that correspond to the respective bits in the digital data signal.

In this situation, in FIG. 12, a digital data signal of 12 bits renders 256 gradations; a single frame is divided into 12 subframes (SF1 to SF12) in such a way that the subframes correspond to the digital data signal of 12 bits.

Among 12 subframes (SF1 to SF12), a first subframe (SF1) corresponds to the most significant bit in the digital data signal.

Each of 12 subframes (SF1 to SF12) is divided into a light-emitting time (LT1 to LT12) and a non-light-emitting time (UT1 to UT12).

In this situation, in order to make the 12-bit digital data signal render 28 (256) gradations, a binary code represented by 1, 2, 4, 8, 16, 32, and so on or a non-binary code represented by 1, 2, 4, 6, 10, 14, 19, and so on can be utilized as the light-emitting time (LT1 to LT12) of each subframe (SF1 to SF12).

During each subframe (SF1 to SF12) period, the whole pixels are scanned vertically, e.g., in a direction from the top to the bottom of the EL panel, so that the EL display device emits light.

Accordingly, the respective light-emitting times of the subframe (SF1 to SF12) periods are formed along the slanted lines, as represented in FIG. 12, within the subframes (SF1 to SF12).

By combining all the light-emitting times (LT1 to LT12) within the respective subframes (SF1 to SF12) in a single frame, the gradation of a desired image can be rendered.

In addition, the example in FIG. 12 represents a case where one frame is configured with a plurality of subframes each having only two states, i.e., a light-emitting state and a non-light-emitting state (That is to say, there exists no gradation); however, each subframe may be configured in such a way as to have not only two states (the light-emitting state and the non-light-emitting state) but also a gradation.

In the foregoing gradation control method through a conventional time-division drive, in order to increase the number of gradations so as to render desired gradation, it is required to divide one frame into a great number of subframes; therefore, unless data pieces are set for all the respective bits corresponding to a great number of subframes obtained through the division, including subframes in a dark-gradation portion, a driver (driver IC) for the display device cannot be driven.

For example, assuming that the number of output terminals of the driver IC is 16 and the number of gradations is 12, unless data pieces corresponding to bits in number of 16 by 12 are set, the driver IC does not operate.

One frame is divided into a great number of subframes and data pieces are set for all the bits corresponding to the great number of subframes obtained through the division in order to perform display, so that there can be performed gradation control having a high display quality.

However, it is not possible to set data pieces for all the subframes at the same time; therefore, it is required to set data pieces one by one, whereby the data setting time increases as the number of subframes increases.

In a practical display device, a plurality of driver ICs is connected in a cascade manner; therefore, unless data pieces for bits in number of 16 by 12 are set for all the driver ICs, the display device, as a panel, cannot perform display.

In recent years, competition for the number of gradations is fierce, and the number of data pieces to be set increases as the number of gradations increases; thus, it takes a long time to set data pieces.

Even though it is requested to perform complicated gradation control in order to improve the display quality and the display function, the longer the time for setting data pieces is, the shorter the time for performing the complicated gradation control becomes.

Additionally, in the case where a great number of driver ICs are connected in a cascade manner, it is required to set data pieces for a great number of outputs; therefore, the data setting time becomes longer than a predetermined light-emitting time, whereby the conventional methods cannot work well.

The increase in the number of data-setting instances, i.e., in the data setting time reduces the time during which lighting can actually be performed.

### SUMMARY OF THE INVENTION

The present invention has been implemented in order to solve the foregoing problems; the objective thereof is to provide a gradation control method, for a display device, in which increase in the data setting time can be suppressed, even if the number of subframes is increased in order to enable complicated gradation control.

In the gradation control method, for a display device, according to the present invention, one frame is divided into a plurality of subframes and the lighting times for pixels corresponding to the subframes are controlled based on the sum of the respective light-emitting times in the subframes, so that the gradations of the pixels are rendered; the frame is divided into n (positive integer) subframes in each of which m (positive integer)-bit data is set and a subframe in which p (positive integer smaller than m)-bit data is set.

As a result, according to the present invention, increase in a data setting time can be suppressed, even if the number of subframes is increased in order to enable complicated gradation control.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a chart for explaining the basic concept of a gradation control method according to Embodiment 1;

FIG. 2 is a diagram illustrating a configuration example of a driver IC for a display device to which the present invention is applied;

FIG. 3 is a diagram for explaining a gradation control method according to Embodiment 2;

FIG. 4 is a chart for explaining a lighting pattern for repeated lighting data and one-shot lighting data in FIG. 3;

FIG. 5 is a chart for explaining the outline operation of a PWM circuit illustrated in FIG. 3;

FIG. 6 is a diagram for explaining a gradation control method according to Embodiment 3;

FIG. 7 is a table representing setting modes set in the 4-bit register in FIG. 6;

FIG. 8 is a chart for explaining an example of methods of utilizing the shift registers in FIG. 6;

FIG. 9 is a conceptual chart for explaining the operation of the repeated lighting data buffer 65 in FIG. 6;

FIG. 10 is a diagram for explaining the operation of a ring buffer;

FIG. 11 is a set of tables representing the switching operations of the switches in FIG. 10 and the M7 commands in FIG. 9; and

FIG. 12 is a chart representing data timing, through a time-division drive, in a typical EL display device.

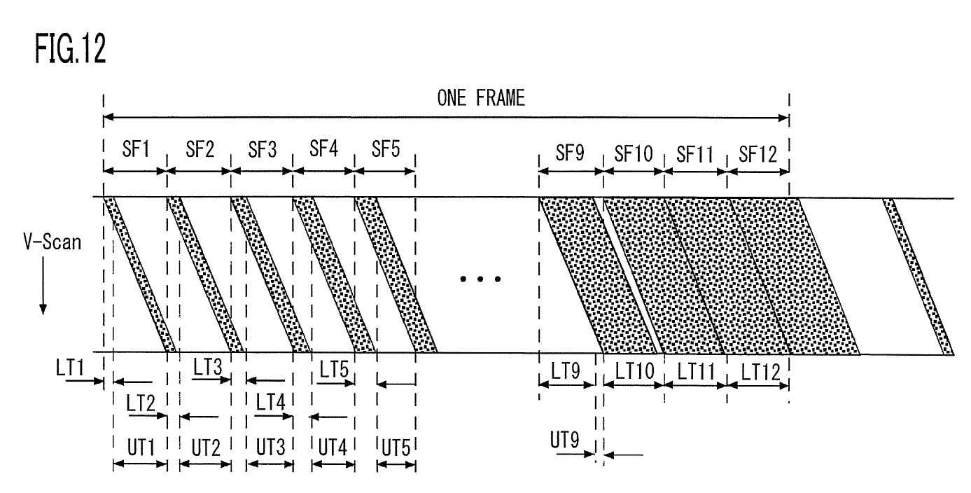

### DETAILED DESCRIPTION OF THE INVENTION

Embodiments of the present invention will be explained below with reference to the accompanying drawings.

### Embodiment 1

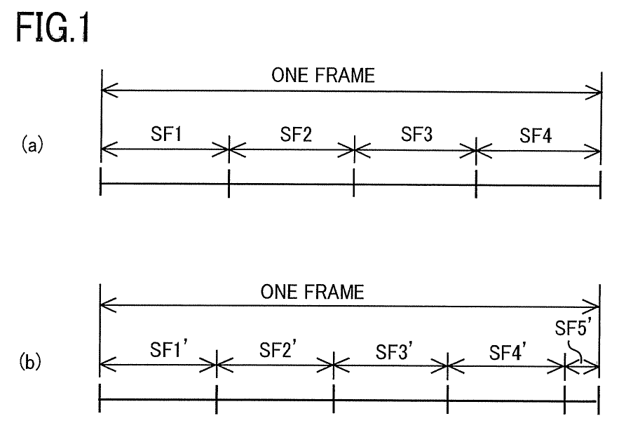

FIG. 1 is a chart for explaining, with regard to one output (one pin) of a driver IC, the basic concept of the subframe division method in a gradation control method according to Embodiment 1.

FIG. 1(a) represents an example of conventional subframe division; FIG. 1(b) represents an example of subframe division according to the present invention.

According to the conventional subframe division, for example, as represented in FIG. 1(a), one frame is divided into four 12-bit subframes (SF1 to SF4); however, in Embodiment 1, as represented in FIG. 1(b), one frame is divided into four 10-bit subframes (SF1′ to SF4′); furthermore, in order to ensure the compatibility with 12-bit subframes/frame, a 2-bit subframe (SF5′) is provided at the fifth position.

In addition, data pieces “1” or “0” are set for the bits in the subframes, in accordance with gradations desired by pixels.

According to the conventional method, for example, the gradation of one frame is controlled through four 12-bit subframes; however, in Embodiment 1, with regard to a bright portion of an image, rough gradation rendering is performed by utilizing the first to the fourth 10-bit subframes (SF1′ to SF4′), and with regard to a dark portion (a portion where changes in brightness of the image are conspicuous), gradation rendering is performed by utilizing the fifth, 2-bit subframe (SF5).

The fifth subframe (SF5′) can be utilized for creating a PWM pulse that is thinner than the LSB (least quantization bit).

In the case where, as represented in FIG. 1(a), one frame is divided into four 12-bit subframes (SF1 to SF4), it is required to set data consisting of 48 bits (12 by 4) (i.e., data pieces that fills up a shift register) for one frame.

Here, 12-bit rendering (4096 gradations) is considered; according to the conventional method represented in FIG. 1(a), for example, in order to render 4096 gradations per frame, it is only necessary that each subframe (SF1 to SF4) has 4096 gradations.

In this situation, in the case where 123/4096 gradations are rendered in one subframe, each subframe (SF1 to SF4) renders 123/4096 gradations.

The number of gradations rendered in one frame corresponds to the average of the numbers of gradations in the respective subframes.

In this case, a data set of 48 bits (12 bits multiplied by 4) is required.

Here, in the case where, in order to render 123/4096 gradations in one frame according to the method represented in FIG. 1(b), each of the subframes SF1′ to SF4′ is configured with 10 bits and SF5′ is configured with only 2 bits out of 10 bits (SF5′ can render 0/1024 to 3/1024), the number of gradations in one frame is 123/1024 (4×30/1024+3/1024) when each of the subframes SF1 to SF4′ is lighted with 30/1024, and SF5′ is lighted with 3/1024.

Because the time period of SF5′ in one frame is sufficiently small ( 1/256, in this case) compared with the time period of each of the subframes SF1′ to SF4′, the number of gradations in one frame is 30.75/1024 when being averaged over four subframes. This numerical value is equal to 123/4096.

In other words, even the method represented in FIG. 1(b) enables 12-bit gradation rendering; therefore, the gradation of an image can be rendered with a 42-bit data set.

Accordingly, according to Embodiment 1, the data setting time can be reduced without deteriorating the gradation control performance (quality).

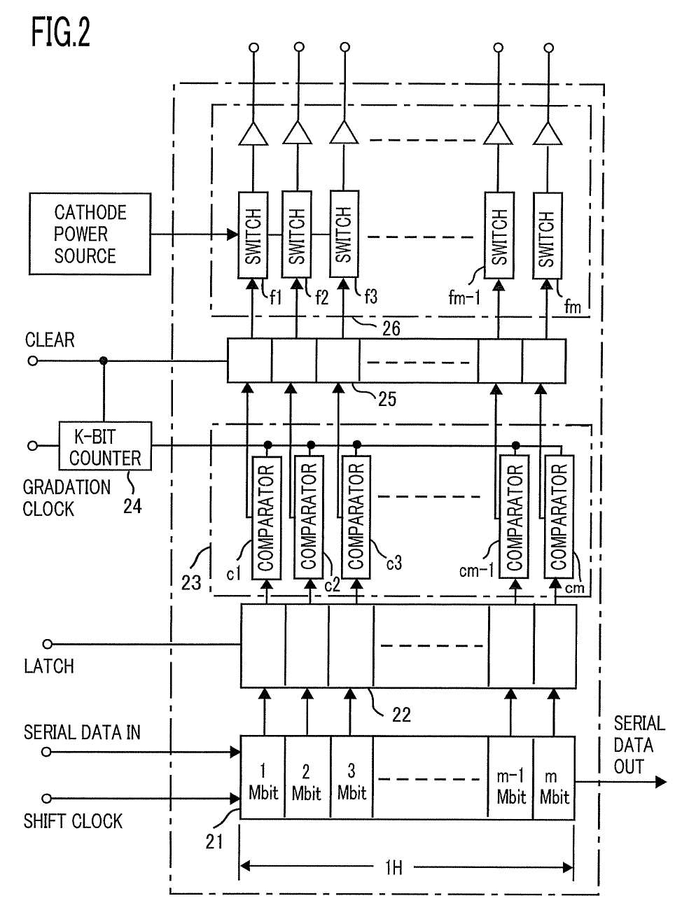

FIG. 2 is a diagram illustrating a configuration example of a driver IC for a display device to which the present invention is applied; there is illustrated an example of a driver IC that receives inputted image data (i.e., data to be set in a frame) and forms a PWM-modulated drive signal.

In FIG. 2, reference numeral 21 denotes a shift register that stores 1H-line image data inputted as a serial data; reference numeral 22 denotes a latch circuit that applies serial-parallel conversion to image data received through the shift register 21 and stores the converted image data for a predetermined time during a horizontal scanning period.

Reference numeral 23 denotes a comparison unit configured with a plurality of comparators; respective image data pieces inputted from the latch circuit 22 and the respective outputs of a counter 24 that counts gradation clocks (PWM clocks) are compared, and until the counter values of the counter 24 coincide with the values of the image data, respective signals are outputted from the comparators in the comparison unit 23 and supplied to a gate unit 25.

The gate unit 25 generates gate signals the pulse width of each of which coincides with a time period between the time instant when the counter 24 is cleared and the data is latched in the latch circuit 22 and the time instant when there is outputted the signals indicating that the counter values of the counter 24 have coincided with the values of the image data, and the gate signals are supplied to a high-voltage buffer unit 26 that is an output unit of the driver IC.

The high-voltage buffer unit 26 is provided with a plurality of buffer amplifiers that are switching-controlled through the gate signals; the buffer amplifiers supply cathode electrodes with a predetermined cathode voltage supplied by a cathode power source.

In addition, a configuration example of a driver IC of this kind is disclosed, for example, in Japanese Patent Laid-Open Pub. No. 2000-214820.

The subframe division method according to Embodiment 1 is applied to a display device utilizing such a driver IC as illustrated in FIG. 2.

As described above, in the gradation control method, for a display device, according to Embodiment 1, one frame is divided into a plurality of subframes and the lighting times for pixels corresponding to the subframes are controlled based on the sum of the respective light-emitting times in the subframes, so that the gradations of the pixels are rendered; one frame is divided into n (positive integer) subframes in each of which m (positive integer)-bit data is set and a subframe in which p (positive integer smaller than m)-bit data is set.

The gradation of a bright portion is controlled through data pieces set in n m-bit subframes, and the gradation of a dark portion is controlled through data set in the p-bit subframe. The p-bit subframe is 1-bit or 2-bit subframe.

Accordingly, even in the case where the number of subframes is increased in order to increase the number of gradations, the number of data sets can be reduced. Even in the case where the number of data sets is reduced, the utilization of p-bit subframe makes it possible to perform gradation rendering equivalent to that to be performed without reducing the number of gradations.

In other words, according to Embodiment 1, the data setting time can be reduced without deteriorating the gradation control performance (i.e., the number of gradations to be rendered).

### Embodiment 2

In Embodiment 1 described above, there has been explained the basic concept of a subframe division method for frame data corresponding to one output (one pin) of a driver IC (i.e., corresponding to one pixel).

In Embodiment 2, there will be described a specific gradation control method for a display device in which a plurality of pixels (display elements) is arranged in a matrix manner so as to form a display screen.

The concept of gradation control for one pixel is basically the same as the gradation control method according to Embodiment 1 described above.

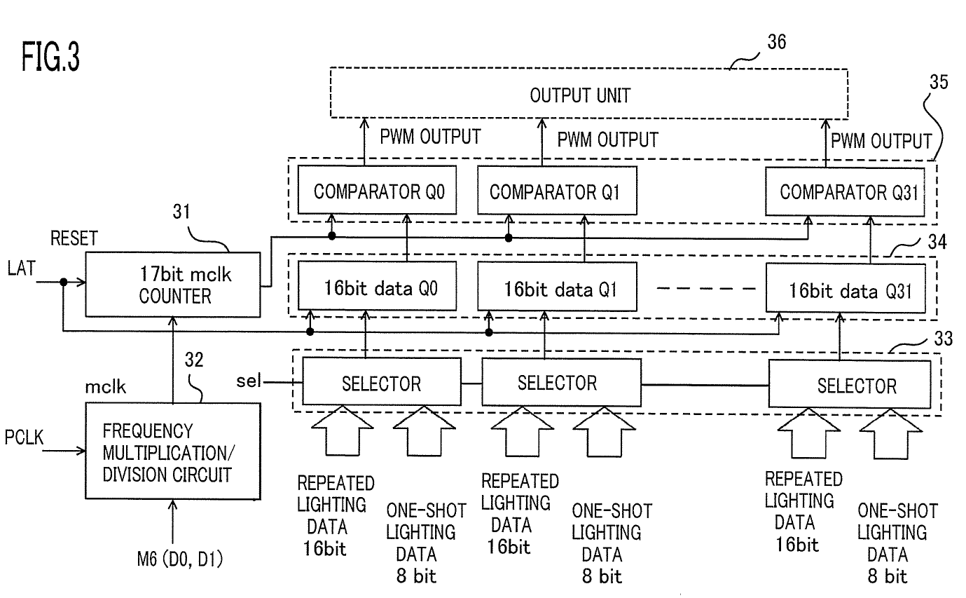

FIG. 3 is a diagram for explaining a gradation control method according to Embodiment 2; there is represented a configuration example of a PWM circuit, according to Embodiment 2, that generates gradation clocks (PWM clocks).

In FIG. 3, reference numeral 31 denotes 17-bit mclk counter; reference numeral 32 denotes a frequency multiplication/division circuit; reference numeral 33 denotes a selector unit; reference numeral 34 denotes a latch circuit unit that latches 16-bit data Q in response to a latch signal; reference numeral 35 denotes a comparator unit; and reference numeral 36 denotes an output unit (32-bit output unit).

In FIG. 3, “LAT” is a latch signal; 16-bit data selected by the selectors in the selector unit 33 is retained as 16-bit data Q0 to Q31, at the rising edge of the latch signal “LAT”.

Simultaneously, during the H-level period of the LAT signal, the counting value of the 17-bit mclk counter 31 is reset to “0”. When the LAT signal falls to the L level thereof, the 17-bit mclk counter 31 starts counting.

“PCLK” denotes a count source clock for obtaining a PWM; the frequency of the PCLK is converter by the frequency multiplication/division circuit 32, e.g., into a frequency four times, twice, the same as, or half as high as that of the PCLK so that the “mclk” signal is obtained, and then the “mclk” signal is inputted to the 17-bit mclk counter 31.

The width of the PWM output varies depending on the frequency outputted from the frequency multiplication/division circuit 32. In other words, when the frequency of the PCLK is quadrupled, the width of the PWM output becomes a quarter as wide as the width at the time when the frequency of the PCLK is not converted.

In order to obtain the PWM, it is required to activate the 17-bit mclk counter 31; the mclk signal serves as a clock for activating the 17-bit mclk counter 31.

A character “sel” is a selection signal for performing switching between repeated lighting data (e.g., 16 bits) inputted to the selector 33 and one-shot lighting data (e.g., 8 bits).

For example, at the timing when “sel” is L-level, the repeated lighting data is selected, and at the timing when “sel” is H-level, the one-shot lighting data is selected.

Each of the comparators in the comparator unit 35 compares the counting output of the 17-bit mclk counter 31 with 16-bit data latched (retained) in the latch circuit unit 34.

In the case where the data retained in the latch circuit unit 34 is larger than the counting value of the 17-bit mclk counter 31, the PWM output of each of the comparators in the comparator unit 35 becomes H-level, and in other cases, the PWM output of each of the comparators in the comparator unit 35 becomes L-level. In this situation, the H level is effective, and the L level is ineffective.

The count source clock mclk inputted to the 17-bit mclk counter 31 is generated by multiplying the PCLK signal inputted to the frequency multiplication/division circuit 32 by 4, 2, 1, or ½, based on a 2-bit signal (D1, D0) set in another register M6.

For example, with regard to the setting of the M6 commands (the setting of the frequency multiplication circuit), dummy data pieces are set for D2 to D15; in the case where (D1, D0) is (0, 0), the frequency of the count source clock mclk is set to a frequency the same as that of the PCLK signal; in the case where (D1, D0) is (0, 1), the frequency of the count source clock mclk is set to a frequency half as high as that of the PCLK signal; in the case where (D1, D0) is (1, 0), the frequency of the count source clock mclk is set to a frequency twice as high as that of the PCLK signal; in the case where (D1, D0) is (1, 1), the frequency of the count source clock mclk is set to a frequency four times as high as that of the PCLK signal.

The selector unit 33 performs selection between 16-bit repeated lighting data and 8-bit one-shot lighting data, based on the sel signal outputted from an unillustrated command register.

The 8-bit one-shot lighting data is packed from the LSB, “0” is inserted into each of 8 bits from the MSB (Most Significant Bit), and then the overall data is outputted.

In addition, Q0 to Q31 in FIG. 3 are not the outputs of subframes but respective data pieces outputted from the pins (32 pins) of the driver IC.

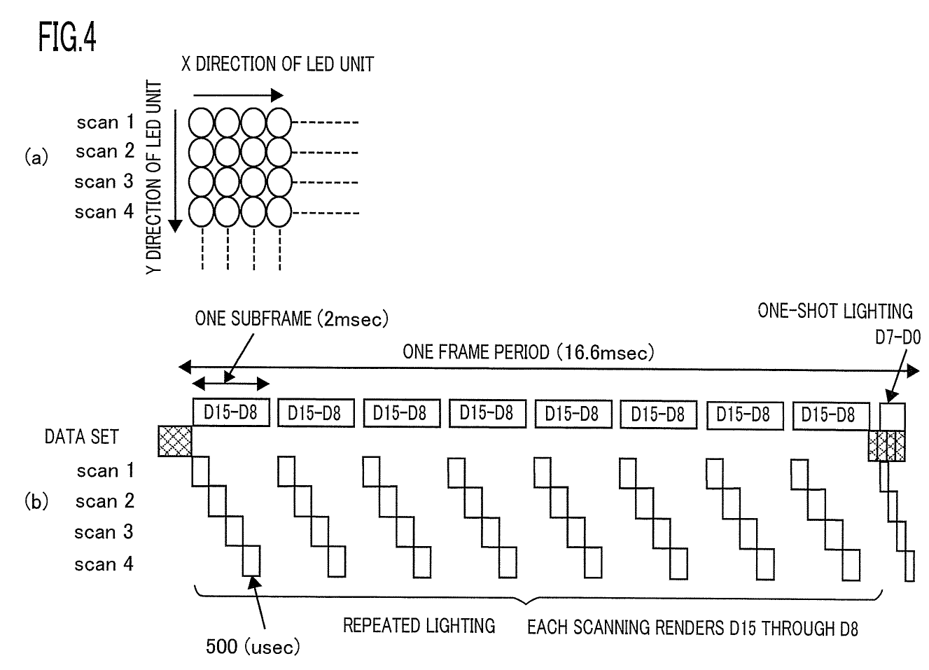

The output from one pin forms such a lighting pattern including subframes as represented in FIG. 4 described later.

FIG. 4 is a chart for explaining a lighting pattern through the “repeated lighting data” and the “one-shot lighting data” in FIG. 3.

FIG. 4 represents a lighting pattern, for example, in the case where gradation rendering is performed with 16-bit gradations, 8 subframes, and 4-line scanning.

As represented in FIG. 4, once data pieces for the first scanning through the fourth scanning have been put into the subframes (i.e., once data pieces have been set), lighting may be performed by repeating the same data pieces eight times.

The gradations from D15 through D8 are repeatedly lighted so that, even in the case where an image is taken by use of a camera, e.g., with a shutter speed of 1/500 sec. (=0.2 msec.), the image is sufficiently formed.

The repeated lighting effectuates an increase in the so-called refresh rate; thus, a flicker in one frame period is reduced.

In FIG. 4, in the case where only D8 is on, the ON period for each subframe is 1.953 (=500/256) μsec.

Because this is lighted eight times, the minimal lighting time becomes 15.625 (=1.953×8) μsec. in the case where only D15 through D8 are lighted.

In the case where all the one-shot lighting pulses for D7 through D0 are “1”, the pulse width becomes 15.564 (15.625/256×255) μsec. This part is one-shot lighting data.

The one-shot lighting data corresponds to data to be set in the subframe of p (e.g., 2) bits, described in Embodiment 1, for performing gradation rendering in a dark portion.

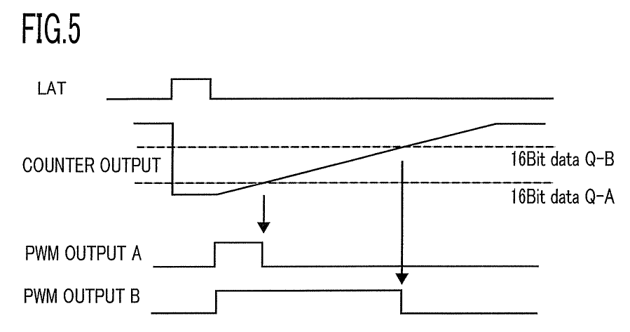

FIG. 5 is a chart for explaining the outline operation of a PWM circuit illustrated in FIG. 3.

In FIG. 5, “LAT” is a signal the same as that represented in FIG. 3; “COUNTER OUTPUT” is the output of the 17-bit mclk counter 31 illustrated in FIG. 3.

“PWM OUTPUT A” is a PWM output that is outputted, for example, in the case the value of the 16-bit data Q is 16-bit data Q-A; “PWM OUTPUT B” is a PWM output that is outputted, for example, in the case the value of the 16-bit data Q is 16-bit data Q-B.

For example, in the case where, when the value of the 16-bit data Q-A is a value of 16 bits, a pulse having a width of maximally 65,536 counts is outputted, a pulse having a width of 200 counts is outputted provided that the value of the 16-bit data Q-A is 200; a pulse having a width of 50,000 counts is outputted provided that the value of the 16-bit data Q-B is 50,000.

In this case, it is a given fact that the output logic of the comparator 35 is made in such a way that, in the case where the 16-bit data Q is larger than the counter value of the 17-bit PCLK counter, the output is H-level, and in the case where the 16-bit data Q is the same as or smaller than the counter value of the 17-bit PCLK counter, the output is L-level.

Due to the operation of the comparator, the PWM output is kept H-level until the counter output exceeds the value of the 16-bit data Q.

As described above, in the gradation control method for a display device according to Embodiment 1, data for pixels in one frame is configured with repeated lighting data set in a m-bit subframe and one-shot lighting data set in a p-bit subframe. By scanning the repeated lighting data so as to light a pixel, the gradation of the pixel is controlled.

In Embodiment 1, the subframe is configured with repeated lighting data and one-shot lighting data; therefore, in the case where it is requested to scan the data a plurality of times so as to display and light an image, once data has been set upon the initial scanning, the same data may be repeated a plurality of times.

### Embodiment 3

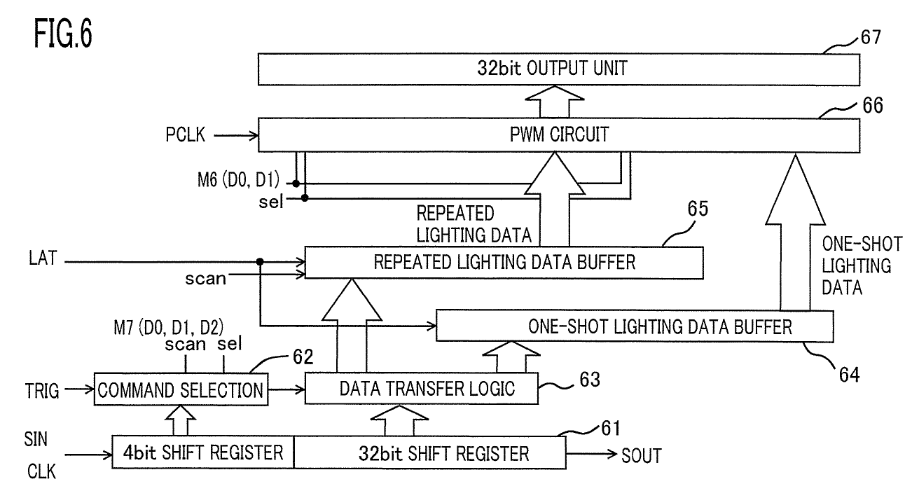

FIG. 6 is a diagram for explaining a gradation control method according to Embodiment 3; FIG. 6 represents the overall data flow in the main part of a system to which a gradation control method according to Embodiment 3 is applied.

In FIG. 6, reference numeral 61 denotes a shift register unit configured with a 4-bit shift register and a 324-bit shift register; reference numeral 62 denotes a command selection unit; reference numeral 63 denotes a data transfer logic unit; reference numeral 64 denotes an one-shot lighting data buffer unit; reference numeral 65 denotes a repeated lighting data buffer unit; reference numeral 66 denotes a PWM circuit; and reference numeral 67 denotes a 32-bit output unit.

The 32-bit output unit 67 corresponds to the output unit 32 in FIG. 3; the PWM circuit 66 corresponds to the PWM circuit (however, excluding the output unit 36) illustrated in FIG. 3.

In the system according to Embodiment 3, a data transfer logic unit described later and a repeated lighting data buffer are provided in the PWM circuit illustrated in FIG. 3.

In addition, in FIG. 6, “TRIG” is a trigger signal; after all data pieces are arranged in the shift register 61, the data pieces arranged in the shift register 61 are received in a parallel manner by the inner circuits by use of the TRIG signal.

In FIG. 6, “SIN” is a serial data input and serves as a data input in the case where data is inputted to the shift register.

“CLK” is a clock input and serves as a clock for sequentially shifting a signal inputted to “SIN”.

“SOUT” is a serial data output and serves as the data output for the “SIN” of the following stage in the case where these circuits are connected in a cascade manner.

Additionally, “scan” denotes designation of the number of scanning instances; the scanning is designated with M7 (D0, D1, D2) so that the number of scanning instances (i.e., the depth of ring buffering) is decided.

For example, in the case where “scan” is 4, four 16-bit data pieces circulate.

Additionally, “sel” is a selection signal for performing switching between the repeated lightning data and the one-shot lighting data; for example, when “sel” is L-level, the repeated lighting data is selected, and when “sel” is H-level, the one-shot lighting data is selected.

In the first place, the logic for data transfer will be explained.

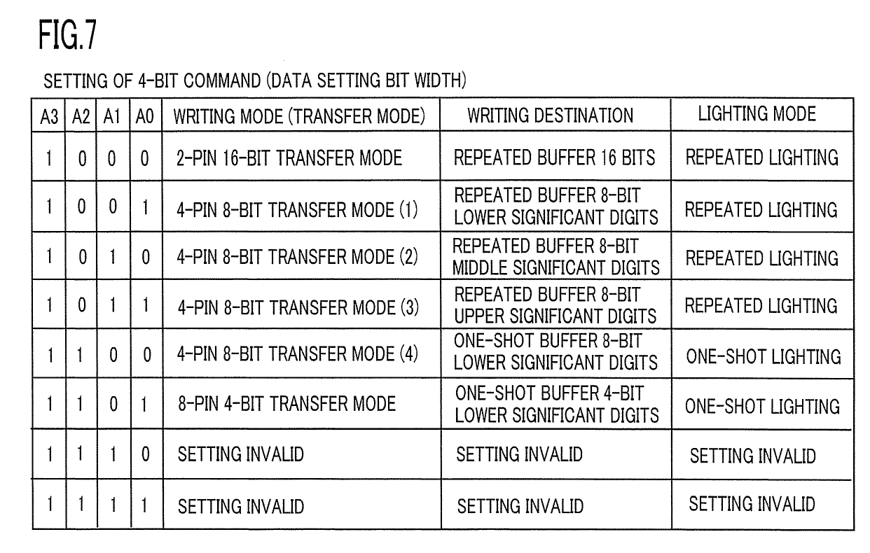

FIG. 7 is a table representing setting modes set in the 4-bit register of the shift register 61 in FIG. 6.

As represented in FIG. 7, by use of a 4-bit (A3, A2, A1, A0) command, a writing mode (transfer mode), a writing destination, and a lighting mode are set.

For example, in the case where (A3, A2, A1, A0) is (1, 0, 0, 0), the writing mode (transfer mode) is “2-pin, 16-bit transfer mode”, the writing destination is “repeated buffer, 16-bit”, and the lighting mode is “repeated lighting”.

In addition, the address of the register (4-bit register) that undergoes increment upon the transition of the command automatically returns to “0”.

In FIG. 7, “2 pin”, “4 pin”, and “8 pin” indicate the respective numbers of outputs that can be written at once in the 32-pin output, through the 32-bit shift register.

“Pin” means an output pin of the IC.

For example, “2-pin 16-bit transfer mode” denotes that setting is performed in such a way that inputted 32-bit shift register data is divided into two data pieces and distributed to 2 pins.

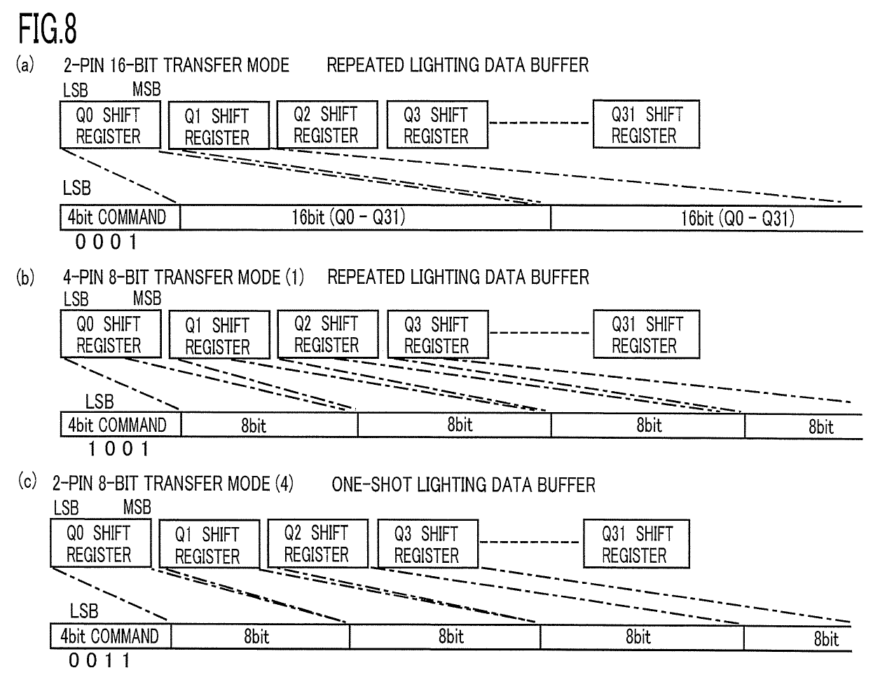

Next, FIG. 8 is a chart for explaining an example of methods of utilizing the shift register 61 in the case where data is set.

In FIG. 8(a), there is represented a case where, in accordance with the 2-pin 16-bit transfer mode, data from the register 61 is transferred to the repeated lighting data buffer 65.

Each time setting is performed, the address of the register automatically undergoes increment, in such a manner as Q0+Q1, Q2+Q3, and so on.

After the 32-bit output is set, the data is automatically transferred to the repeated lighting data buffer 65.

In FIG. 8(b), there is represented a case where, in accordance with the 4-pin 8-bit transfer mode, data from the register 61 is transferred to the repeated lighting data buffer 65. In this case, data pieces for 4 pins are simultaneously set. That is to say, each time setting is performed, the address of the register to be set automatically undergoes increment, in such a manner as Q0+Q1+Q2+Q3, Q4+Q5+Q6+Q7, and so on.

The higher significant digits D15 through D8 of the register to be set are set to “0”.

After the 32-bit output is set, the data is automatically transferred to the repeated lighting data buffer 65.

In FIG. 8(c), there is represented a case where, in accordance with the 2-pin 8-bit transfer mode, one-shot lighting data is transferred to the one-shot lighting data buffer.

Each time setting is performed, the address of the register to be set automatically undergoes increment, in such a manner as Q0+Q1+Q2+Q3, Q4+Q5+Q6+Q7, and so on.

The lower significant digits D7 through D0 of the register to be set are set to “0”.

After the 32-bit output is set, the data is automatically transferred to the one-shot lighting data buffer.

In Embodiment 3, provision of the foregoing transfer modes makes it possible to create various gradation control patterns.

Additionally, 16-bit gradations are obtained through the 2-pin 16-bit transfer mode; however, by combining the 4-pin 8-bit transfer mode (3) and 4-pin 8-bit transfer mode (4), the data setting time can be distributed.

Next, the repeated lighting data buffer (ring buffer) according to Embodiment 3 will be explained.

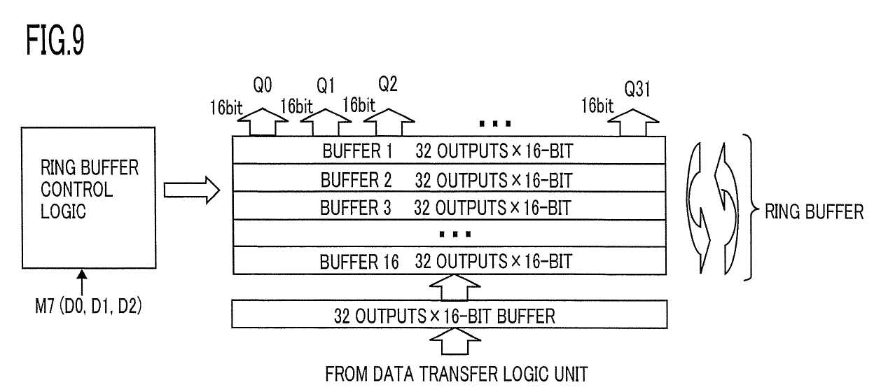

FIG. 9 is a conceptual chart for explaining the operation of the repeated lighting data buffer 65 in FIG. 6.

The repeated lighting data buffer (ring buffer) 65 is to repeat the same data, for example, in such a manner as the scanning (scan1 to scan4) represented in FIG. 4(b).

In addition, “32 outputs” described in each buffer (buffer 1 through buffer 16) in FIG. 9 denotes 32 outputs Q0 through Q31 (respective outputs corresponding to 32 output pins).

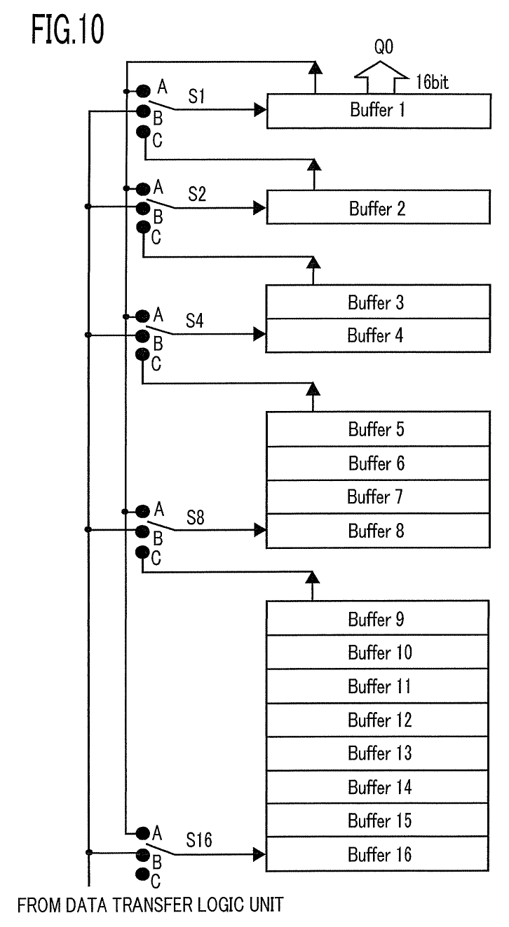

FIG. 10 is a diagram for explaining the operation of a ring buffer in the case where only the output Q0 is extracted.

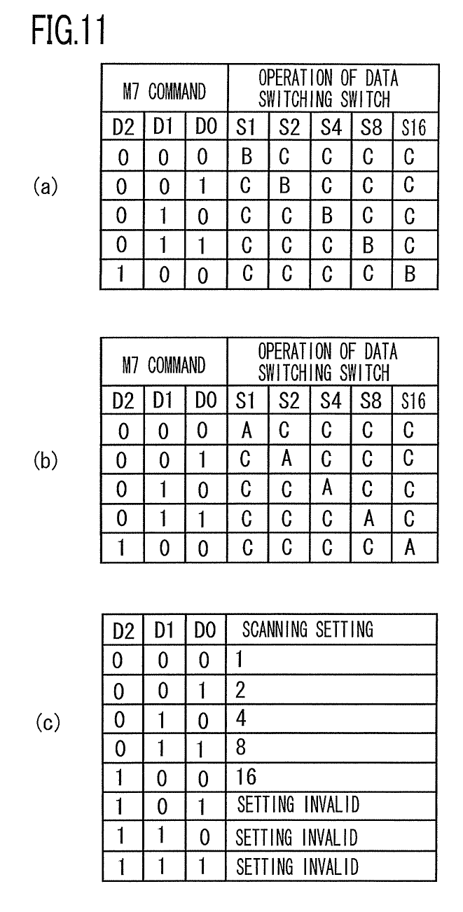

FIG. 11 is a set of tables representing the switching operations of the switches in FIG. 10 and the M7 commands in FIG. 9; FIG. 11(a) represents the switching operation of the switches illustrated in FIG. 10, in the case where data setting is performed based on the data transfer logic; FIG. 11(b) represents the operation of the switches while the repeated data is outputted; FIG. 11(c) represents the meanings of the M7 command for setting a control logic for the ring buffer in FIG. 9.

In the case of 4-scaning system as represented in FIG. 4(b), the M7 command (D2, D1, D0) is (0, 1, 0).

When data is set, the switch S4 for switching data is switched over to “B” and Scan1 data is set in Buffer4.

Next, when scan2 data is set, Scan1 data in the Buffer4 is transferred to Buffer3, and Scan2 data is set in Buffer4.

After Scan3 data and Scan4 data are set following Scan1 data and Scan2 data, Scan1 through Scan4 are sequentially set in each of the buffers Buffer1 through Buffer4.

When the data is outputted repeatedly, Scan1, Scan2, Scan3, and Scan4 are outputted in that order, each time the signal LAT is inputted.

When the data is outputted, the switch S4 is switched over to “A”; when being outputted, Buffer1 data is concurrently transferred to Buffer4. In this manner, a ring-buffer state is formed.

The scanning setting is performed in such a manner as represented in FIG. 11(c), so that the buffer length of the ring buffer can conform to one scanning, 2 scanning, 8 scanning, and 16 scanning in addition to 4 scanning represented in FIG. 4(b).

In Embodiment 3, by forming the foregoing ring buffer, it is not required to set data for each subframe even in the case where data is scanned.

As described above, the repeated lighting data and the one-shot lighting data in the gradation control method according to Embodiment 3 are once integrated in the shift register, and then outputted based on a predetermined data transfer logic. The data transfer logic unit sets a plurality of transfer modes, writing destinations, and lighting modes, based on predetermined commands.

Accordingly, by use of the foregoing transfer modes, various gradation control patterns can readily be created.

The repeated lighting data transferred from the data transfer logic unit is outputted via the repeated lighting data buffer that is included in a ring buffer. A scanning method is set for the ring buffer, through a predetermined control logic.

Accordingly, it is not required to set data for each subframe in the case where data is scanned.

Various modifications and alterations of this invention will be apparent to those skilled in the art without departing from the scope and spirit of this invention, and it should be understood that this is not limited to the illustrative embodiments set forth herein.

What is claimed is:

1. A gradation control method for a display device,
wherein one frame is divided into a plurality of subframes and lighting times for pixels corresponding to the subframes are controlled based on the sum of respective light-emitting times in the subframes, so that gradations of the pixels are rendered, and
wherein the frame is divided into n (positive integer) subframes in each of which m (positive integer)-bit data is set and a subframe in which p (positive integer smaller than m)-bit data is set.

2. The gradation control method according to claim 1, wherein the gradation of a bright portion is controlled through data pieces set in the n m-bit subframes, and the gradation of a dark portion is controlled through data set in the p-bit subframe.

3. The gradation control method according to claim 1, wherein the p bit is 1 bit or 2 bit.

4. The gradation control method according to claim 1, wherein data pieces for the pixels in one frame are configured with repeated lighting data pieces set in the m-bit subframes and one-shot lighting data pieces set in the p-bit subframes.

5. The gradation control method according to claim 4, wherein, by scanning in accordance with the repeated lighting data so as to light a pixel, the gradation of the pixel is controlled.

6. The gradation control method according to claim 4, wherein the repeated lighting data and the one-shot lighting data are once integrated in the shift register, and then outputted based on a predetermined data transfer logic.

7. The gradation control method according to claim 6, wherein, in the data transfer logic, a plurality of transfer modes, writing destinations, and lighting modes are set based on predetermined commands.

8. The gradation control method according to claim 6, wherein the repeated lighting data transferred in accordance with the data transfer logic is outputted via a repeated lighting data buffer that is included in a ring buffer.

9. The gradation control method according to claim 7, wherein the repeated lighting data transferred in accordance with the data transfer logic is outputted via a repeated lighting data buffer that is included in a ring buffer.

10. The gradation control method according to claim 8, wherein a scanning method is set for the ring buffer, in accordance with a predetermined control logic.

11. The gradation control method according to claim 9, wherein a scanning method is set for the ring buffer, in accordance with a predetermined control logic.

12. A display device, wherein a plurality of pixels is arranged in a matrix manner, and respective gradations of the arranged pixels are controlled in accordance with the gradation control method according to claim 1.

13. A display device, wherein a plurality of pixels is arranged in a matrix manner, and respective gradations of the arranged pixels are controlled in accordance with the gradation control method according to claim 2.

14. A display device, wherein a plurality of pixels is arranged in a matrix manner, and respective gradations of the arranged pixels are controlled in accordance with the gradation control method according to claim 3.

15. A display device, wherein a plurality of pixels is arranged in a matrix manner, and respective gradations of the arranged pixels are controlled in accordance with the gradation control method according to claim 4.

16. A display device, wherein a plurality of pixels is arranged in a matrix manner, and respective gradations of the arranged pixels are controlled in accordance with the gradation control method according to claim 5.

17. A display device, wherein a plurality of pixels is arranged in a matrix manner, and respective gradations of the arranged pixels are controlled in accordance with the gradation control method according to claim 6.

18. A display device, wherein a plurality of pixels is arranged in a matrix manner, and respective gradations of the arranged pixels are controlled in accordance with the gradation control method according to claim 7.

19. A display device, wherein a plurality of pixels is arranged in a matrix manner, and respective gradations of the arranged pixels are controlled in accordance with the gradation control method according to claim 8.

20. A display device, wherein a plurality of pixels is arranged in a matrix manner, and respective gradations of the arranged pixels are controlled in accordance with the gradation control method according to claim 9.

21. A display device, wherein a plurality of pixels is arranged in a matrix manner, and respective gradations of the arranged pixels are controlled in accordance with the gradation control method according to claim 10.

22. A display device, wherein a plurality of pixels is arranged in a matrix manner, and respective gradations of the arranged pixels are controlled in accordance with the gradation control method according to claim 11.
